(19) United States
(12) Patent Application Publication
(10) Pub. No.: US 2005/0175939 A1
(43) Pub. Date: Aug. 11, 2005

(54) Percolated metal structure with electrochromic and photochromic properties

(76) Inventors: Piero Perlo, Cuneo (IT); Nello Liira, Cuneo (IT); Rossella Monferino, Torino (IT); Mauro Brignone, Torino (IT); Piermario Repetto, Torino (IT); Vito Lambertini, Torino (IT); Daniele Pullini, Torino (IT); Roberto Finizio, Torino (IT); Filippo Bernard, Torino (IT)

Correspondence Address: SUGHRUE MION, PLLC, 2100 PENNSYLVANIA AVENUE, N.W., SUITE 800, WASHINGTON, DC, 20037, US

(21) Appl. No.: 10/516,098

(22) PCT Filed: Oct. 31, 2003
(86) PCT No.: PCT/IB03/04907

(30) Foreign Application Priority Data
Dec. 20, 2002 (IT) TO2002A001110

(51) Int. Cl. G03C 5/00

(52) U.S. Cl. 430/322

(57) ABSTRACT

Bidimensional or three-dimensional, single-layer or multilayer nanostructure, whose electric conductivity B in the total structure has a highly non-linear behavior due to local tunnel effect between adjacent clusters, and it can be varied at will by varying the voltage applied to the electrodes.

### FIELD OF THE INVENTION

The present invention relates to percolated metal films.

A percolated metal film is a bidimensional or three-dimensional nanostructured metal structure, consisting of metal clusters interconnected one to the other or coupled by tunnel effect, so as to ensure electric conduction. Said structure is generally obtained by an evaporation process (thermal or with e-beam), or by sputtering processes through Chemical Vapor Deposition or Supersonic Cluster Beam via Pulsed Microplasma Sources.

The electric and electronic behavior of said films has shown that the conductivity σ of the system as a whole is not constant, but varies depending on the voltage applied to the ends of said films. The possibility of a relatively simple control of conductivity σ of a discontinuous metal film makes this system interesting for applications based on electrochromic effect. By this we mean a variation of optical properties, and in particular of absorption, of transmittance and of reflectance, and therefore of the color associated to the variation of applied voltage.

Conversely, film photochromic properties can be the result of the polarizability of the single clusters due to a field of light. Clusters behave like particle plasmons depending on the applied optical filed.

### BACKGROUND OF THE INVENTION

### Electrochromic Materials

Electrochromic materials are materials showing a manifest change in their absorption spectrum (and therefore in their color) associated to the injection or extraction of electrons (and/or ions).

With reference to FIG. 1 of the accompanying drawings, electrochromic devices generally comprise multilayer structures as the one shown in the figure mentioned above, including a transparent electrode 1, covered with a layer 2 of electrochromic material, a spacing layer 3 incorporating an electrolyte 4 and eventually a second electrode.

The electric field applied between the two electrodes injects electric charges into the electrochromic film, thus causing the variation of its absorption spectrum.

There are several electrochromic materials, both organic and inorganic. Among all of them, the one having a dominant position in practical devices is tungsten trioxide (WO₃). Among the materials showing the so-called cathodic coloration the following can be mentioned: MoO₃, V₂O₅, Nb₂O₅ and TiO₂; among those showing anodic coloration: IrO₂, Rh₂O₃, CoOₓ and NiOₓ. The interest towards electrochromic phenomena has recently been directed towards the cases of some electrically active polymers (such as for instance polyaniline) and biological polymers.

Differently from conventional photochromic materials, comprising for instance glass metal ions, the percolated metal film changes its optical properties since clusters behave like metal plasmons, i.e. they are polarized by the incident optical field.

### Tunnel Effect in Percolated Metal Films

A metal film at percolation level consists of a mesoporous metal structure comprising metal nanoparticles interconnected one to the other or coupled by tunnel effect, so as to ensure electric conduction. The percolation level is defined as the point in which during film deposition process the system shifts from an insulating to a conductive behavior.

Production techniques of these percolated films include thermal evaporation or evaporation with e-beam, co-evaporation, sputtering and several techniques envisaging self-assembly of metal and semiconductor colloidal particles, or pulsed microplasma techniques.

The interface metal-insulator is a typical situation within a metal system at percolation level, which occurs at every discontinuity of said system.

There are several mechanisms of electronic transport through the interface metal-insulator: ohmic conduction, ionic conduction, thermal emission, emission by field effect or Fowler-Nordheim electronic tunneling. In a given material each of the aforesaid mechanisms dominates within a given temperature and voltage range (electric field) and has a characteristic dependence on current, on voltage and on temperature. These different processes are not necessarily independent one from the other.

Emission by field effect, also known as Fowler-Nordheim electronic tunneling, consists in the transport of electrons through an interface metal-insulator due to the shift—occurring by tunnel effect—of said electrons from Fermi metal level to the conduction band of the insulator. This tunnel effect occurs in the presence of strong electric fields (whence its name: emission by field effect), which are able to bend the energy bands of the insulator until they form a narrow triangular potential barrier between metal and insulator.

It is generally believed that the potential energy of an electron goes from zero within the metal to a value E_{F}+Φ straight outside metal surface. In FIG. 2 of the accompanying drawings this case is represented by curve (a). However, the potential barrier met by an electron going away from the metal has a more gradual course: it can be reasonably believed that at first potential grows linearly together with the distance from metal surface; but when an electron comes to a distance of some Å from said surface, it should feel the effect of an attracting force corresponding to the force due to a charge −e, in whose presence the potential energy of said electron becomes:

$$V ( x ) = ( {E}_{F} + Φ ) - ( \frac{{ⅇ}^{2}}{16 π {ɛ}_{0} x} )$$

x being the distance of the electron from metal surface. In FIG. 1 this case is represented by curve (b). Eventually, by applying an electric field in x direction in the vacuum region surrounding the metal, the potential energy of the electron becomes:

$$V ( x ) = ( {E}_{F} + Φ ) - ( \frac{{ⅇ}^{2}}{16 π {ɛ}_{0} x} ) - e x E$$

where E is the applied electric field. By executing the derivative of this expression the presence of a maximum of potential barrier can be found out, as represented in FIG. 1 by curve (c), which is on:

$$\{ \begin{matrix}{x}_{max} = {( ⅇ / 16 π {ɛ}_{0} E )}^{1 / 2} \\ {V}_{max} = V ( x ) = ( {E}_{F} + Φ ) - {( {ⅇ}^{3} E / 4 π {ɛ}_{0} )}^{1 / 2}\end{matrix}$$

As can be observed in FIG. 2, the presence of an outer electric field results in a slight reduction of effective work function. The reduction of the value of metal typical work function under vacuum is small if the outer electric field is not very intense (up to a value of some thousands volts/meter): in such a case the maximum potential is many Å away from the outer surface of the metal. Even a small reduction of Φ value, however, can result in the thermoemission phenomenon for many electrons that do not have sufficient energy to go beyond the potential barrier in the absence of the outer electric field.

When the electric field become highly intense, around 10⁹ volts/meter, beyond the reduction of metal typical work function, another phenomenon occurs, referred to as emission by tunnel effect or electronic tunneling. The potential barrier generated on the surface metal/insulator becomes so thin as to be gone through, by quantum tunnel effect, by metal electrons. If the electric field has a critical value, the potential barrier becomes sufficiently thin and the electrons which are on metal Fermi level acquire a finite probability to go through said barrier. For higher values of the electric field, the even smaller thickness of potential barriers enables electrons with even lower energies to go through them by tunnel effect.

The density of current emission by tunnel effect strictly depends on the intensity of the electric field, but does not basically depend on temperature:

$$j ∝ {E}^{2} exp ( - \frac{b Φ}{E} )$$

where E is the intensity of the electric field, Φ is the height of the potential barrier, b is a proportionality constant.

It should be pointed out that in case of emission by electronic tunneling electrons do not require any thermal excitation (and this explains why j does not depend on temperature), but an intense electric field reducing the thickness of the potential barrier and bending the conduction and valence bands of the insulator. This explains the strict dependence of j on the intensity of the electric field. As a matter of fact, in this case electrons do not go beyond but through the potential barrier.

Tunneling probability for Fermi level electrons should be quite small, unless the barrier is less than 10 Å thick. That is way it can be reasonably expected that the critical value of the electric field, above which emission by field effect occurs, is of about 3·10⁹ volts/meter. Conversely, this kind of emission occurs also with macroscopic electric fields up to 30 times less intense. Local irregularities of the metal surface are likely to be the cause of the presence of highly intense electric fields, but only locally, and most of the emission by field effect is likely to come from these areas.

Within a percolated metal system, and in particular on each interface metal-vacuum, there are local increases of the electric field reaching values of intensity of the electric field enabling electronic tunneling effect. It should be stressed that the local increase of the electric field is the higher the smaller are the areas concerned by field emission. On each discontinuity of the percolated metal system, where a local increase of the electric field takes places and electric emission by field effect occurs, there should be a local increase of current density. As a matter of fact, the electrons emitted by field effect, as well as those deriving from thermoemission, contribute to total electric current. Because of this the percolated metal system should have a voltage-current characteristic curve with ohmic course: the increase of current together with applied voltage, thanks to thermoemission and of emission by field effect, should be faster than in an ohmic conductor with linear characteristic.

Non-linear electric characteristic have been measured for bidimensional percolated metal systems, and in particular in discontinuous metal films laid onto glass substrates by thermal evaporation or with e-beam.

FIGS. 3, 4 and 5 of the accompanying drawings show the structure of discontinuous metal films at percolation level and their non-linear electric characteristics.

FIG. 3 schematically represents the structure of a bidimensional discontinuous metal film at percolation point. The continuous lines are the continuous paths on which electric current passes from one electrode to the other. The separation between the metal particles forming the bidimensional percolated film is of 1-5 nm.

FIG. 4 shows the electric characteristics of three different bidimensional percolated metal films (Au, Ag, Al), having a length (distance between the electrodes) of 0.5 mm, and a thickness of 2-5 nm, under vacuum. The non-ohmic course of curves I-V is quite manifest.

FIG. 5 shows the electric characteristic of a bidimensional percolated copper film, having a width of 0.5 mm and a thickness of 2 nm, in air (packaging with a resist layer). Also in this case the non-ohmic course of curves I-V is quite manifest.

The electronic mobility within the system, and as a consequence electric conductance, differs from standard electronic motion in a conductor. As a matter of fact, resistance does not depend on the collisions of electrons, but on a complex network of nanowires behaving like electronic waveguides. The paths connecting the two lateral electrodes form a bidimensional group of nanometric channels (nanoelectrodes) through which electrons can flow. The structure is in all respects a fractal system in which local distances between the nanoelectrodes are of some Armstrongs: by applying a voltage of some volts to the two lateral electrodes, the local field reaches a value of 10⁶⁻⁷ V/cm, which is sufficient to cause electronic tunneling within the structure.

Conductance is given by G=I/V where I is current across the conductor and V is applied voltage; each channel, in a system without obstacles, is dominated by a quantum conductance of G₀=2e²/h (where h is Planck's constant) and for N channels the maximum conductance value is G=NG₀=2Ne²/h.

The global area of the percolated film defines the number N of accessible channels: after a first approximation N is directly proportional to film length and to the ratio of a specific length L_{C} to the distance d between the two electrodes to which voltage is applied: L_{C}, said characteristic length, is the distance between two hypothetical electrodes connected by tunnel effect with the minimum possible path. If L_{C}>d, electrons go from one electrode to the other with a path having a total length d. If L_{C}<d, electrons go from one electrode to the other following a segmented path with a total length greater than d.

This measure, determined experimentally, depends on the material, on the method of deposition and on the substrate.

### Electrochromic Effect in Percolated Metal Films

A percolated metal film has a voltage-current characteristic with non-ohmic course, and the non-linear increase of current flowing into the system is due to the contribution of charge transport caused by the emission by tunnel effect i.e. by electronic tunneling.

Such a characteristic shows quite clearly how the conductivity σ of the system as a whole depends on the voltage applied to the ends of said system.

As is known, the optical properties of a system are strictly related to its electric properties.

In particular, the dielectric constant ε of a system is related to its conductivity σ through:

$$ɛ ( ω ) = {ɛ}_{0} ( ω ) + \frac{4 π ⅈ}{ω} σ ( ω ) .$$

To the dielectric constant ε of the system is then related the refractive index of the medium n=n+ik:
ε=n²=n²−k²+2ink.

Eventually, the optical properties of the system, among which transmittance T and reflectance R, absorption A and therefore color, depend on the refractive index n.

In the particular case of normal incidence (θi=0) the relations of T and R with the refractive index (real part n) are as follows:

$$\begin{matrix}R = {( \frac{{n}_{i} - {n}_{t}}{{n}_{i} + {n}_{t}} )}^{2} \\ T = \frac{4 {n}_{i} {n}_{t}}{{( {n}_{i} + {n}_{t} )}^{2}}\end{matrix}$$

After a first approximation, the intensity of a wave absorbed by the material is related to the refractive index (imaginary part k) and is as follows:
I_{abs}=I₀ exp[−2kωr/c]
where α=2ω/c is referred to as absorption index.

The possibility of controlling the conductivity σ of the percolated metal film through the voltage applied to its ends thus results in the possibility of controlling T, R, A and color in said film.

Aim of the Invention

The aim of the present invention is to propose a percolated metal film in which absorption, transmittance, reflectance and therefore color can be controlled by applying a convenient electric voltage, so as to make the film suitable for various applications in the field of photonic optics, for instance for spectacles, for electronically controlled optical glasses and mirrors, for filters with electronically controlled passband, for car windscreens and windows, etc.

### SUMMARY OF THE INVENTION

The object of the present invention is a percolated metal structure having the characteristics as defined in the enclosed claim 1. Further preferred characteristics of the invention are defined in the claims following claim 1.

The electrochromic device according to the invention, based on a percolated metal film, is characterized by a “flat” structure and comprises the following parts:
1. A transparent glass substrate,
2. Two lateral electrodes,
3. An active layer of nanostructured metal material at percolation level, and
4. A transparent protective layer.

### BRIEF DESCRIPTION OF THE DRAWINGS

FIG. 1 shows a conventional electrochromic device, as already described above,

FIG. 2 is a diagram showing the potential barrier between metal and vacuum, as already described above,

FIG. 3 shows the structure of a bidimensional discontinuous metal film at percolation point, as already described above,

FIG. 4 is a diagram showing the electric characteristics of three different bidimensional percolated metal films, as already described above,

FIG. 5 is a diagram showing the electric characteristic of a bidimensional percolated copper film, as already described above,

FIG. 6 shows schematically the electrochromic device based on a percolated metal film according to the invention,

FIG. 7 shows the application of the invention to glass lenses,

FIG. 8 shows schematically the electrochromic coating laid onto the lens of the pair of glasses of FIG. 7.

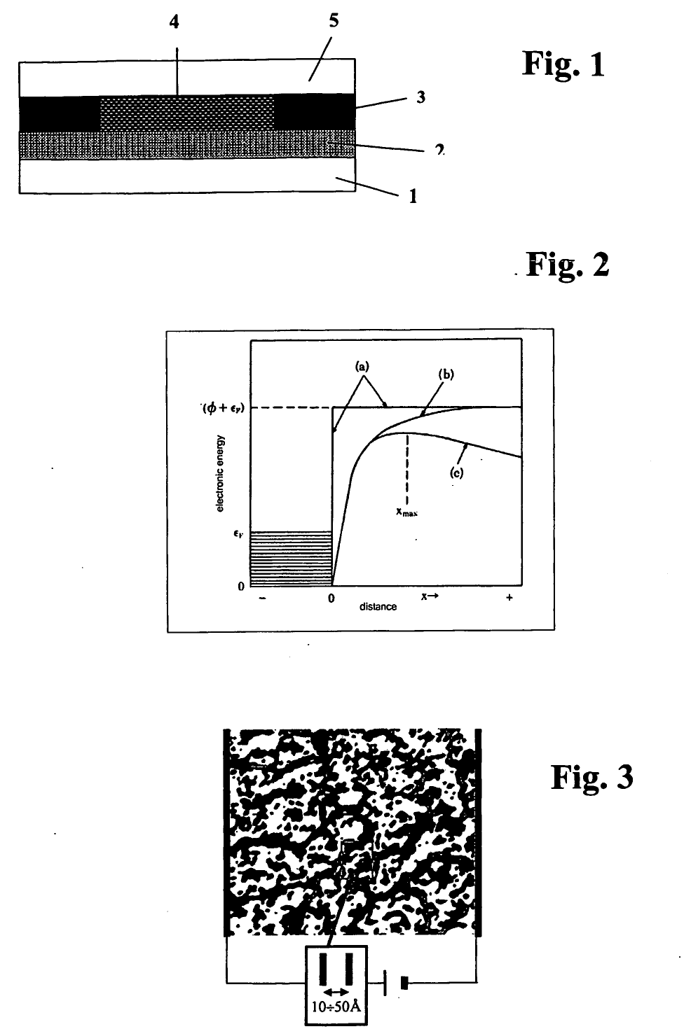

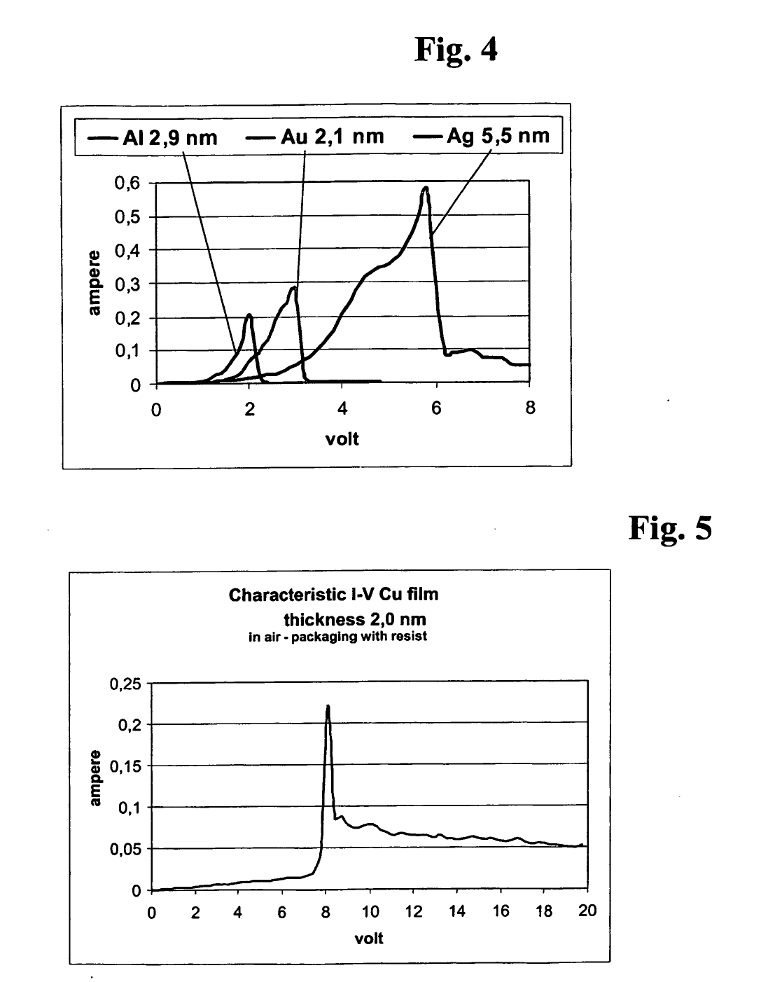

### DETAILED DESCRIPTION OF A PREFERRED EMBODIMENT

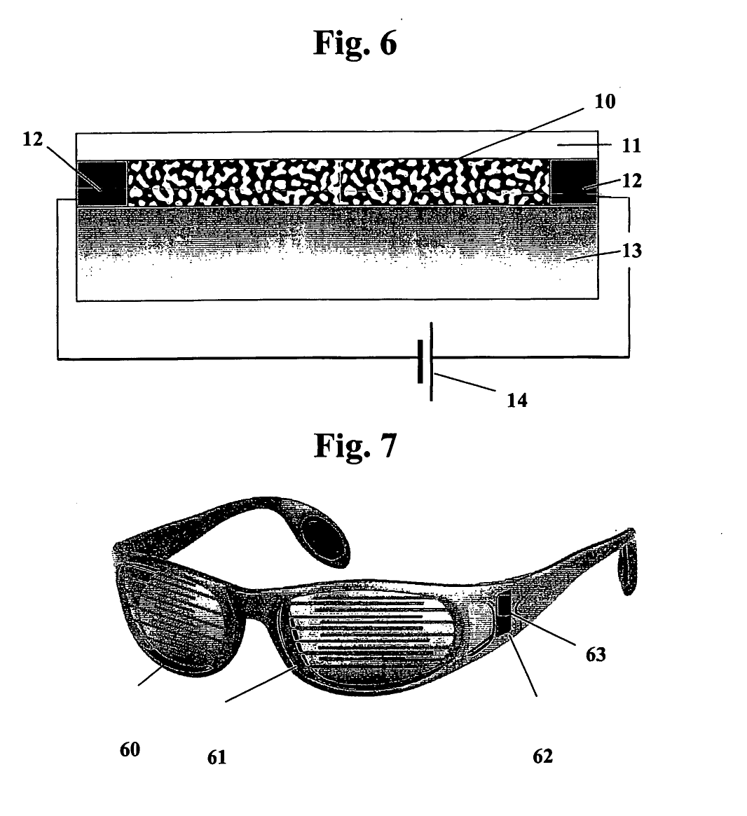

With reference to FIG. 6, the electrochromic device according to the invention, based on a percolated metal film, is characterized by a “flat” structure and comprises the following parts:
1. A transparent glass substrate 13,
2. Two lateral electrodes 12 connected to a supply 14,
3. An active layer 10 of nanostructured metal material at percolation level, and
4. A transparent protective layer 11.

### Transparent Substrate

The substrate used is common glass or as an alternative a plastic material such as polycarbonate, methacrylate, CR39, etc., prepared with an ultrasonic cleaning process.

Therefore, transparent substrates covered with particular expensive coatings, such as for instance ITO-covered glass, are not required.

### Lateral Electrodes

The two electrodes are placed in contact with the two lateral surfaces of the percolated metal structure and comprise a continuous metal layer (copper, silver, gold, aluminum, etc.) laid by evaporation or by serigraphy onto the glass or polymer substrate.

The electrodes enable to establish the electric contact between the supply generator of the electrochromic device and the active layer of said device, i.e. the nanostructured metal film at percolation level. The electrodes generate at the ends of the nanostructured mesoporous layer a potential difference causing the transport of electric charge through said layer. If the applied voltage is sufficiently high to create very intense local electric fields (E≈10⁷ V/cm), electronic conduction by tunnel effect occurs within the metal layer at percolation level.

### Layer of Mesoporous Metal Material at Percolation Level

The active layer of the electrochromic device is the nanostructured metal film at percolation level.

As was already said, the percolation point of a discontinuous metal system is defined as the point in which the film shifts from an insulating behavior, characterizing the situation in which the film has a large number of discontinuities with respect to metal islands, to a conductive behavior, characterizing the situation in which within the film, metal islands prevailing over discontinuities, direct links between the two ends of said film are formed, in which electric current can be conducted. The passage of electric current through the film is due both to normal ohmic conduction and to transport mechanisms involving the interface areas between metal and discontinuities, and in particular to electronic tunneling.

The evidence of electronic tunneling is given by the non-linear course of the voltage-current characteristic of percolated metal films. It shows a relevant increase of current related to the presence of a critical value of applied voltage. Therefore, if the critical voltage value is present, the conductivity σ has a sudden increase.

Indeed, the variation of the conductivity σ of the system together with the application of an electric field to the percolated metal film makes the latter very interesting for applications in an electrochromic device.

### Transparent Protective Layer

The transparent protective layer consists of a very thin transparent glass (in the range of microns), produced with sol-gel process and laid onto the percolated metal layer by spin coating or dip coating.

Thus, the protective layer of the electroluminescent device based on tunnel effect in a percolated metal system, beyond being easy to be prepared and laid with respect to the conventional technology of electrochromic films, reduces the total cost for manufacturing the device.

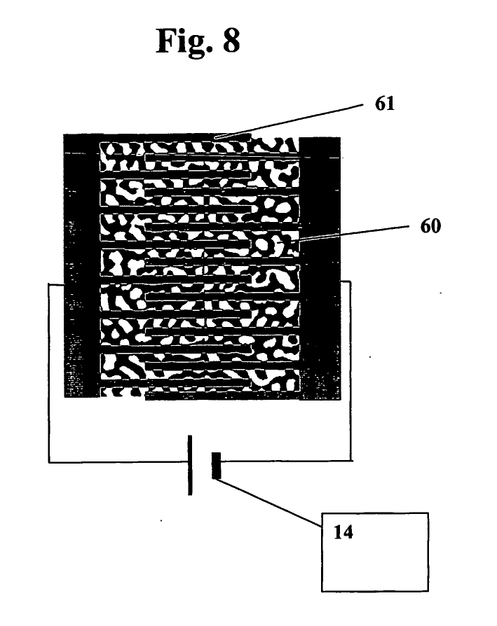

FIG. 7 shows an application of the invention to the lenses of a pair of glasses in order to vary the reflectance and transmittance of an electrochromic coating 60 equipped with comb-like electrodes 61 on a glass or plastic substrate constituting each lens of the pair of glasses. A solar cell 62 (in amorphous or polycrystalline silicon) is used, which alone or coupled to a photovoltaic diode 63 controls and supplies with feedback action the reflectance/transmittance value of the percolated film. FIG. 8 shows schematically the electrochromic coating laid onto the lens of the pair of glasses of FIG. 7, showing the semitransparent continuous metal electrodes arranged in comb form.

Obviously, though the basic idea of the invention remains the same, construction details and embodiments can widely vary with respect to what has been described and shown by mere way of example, however without leaving the framework of the present invention.

1. Bidimensional or three-dimensional, single-layer or multi-layer nanostructure, whose electric conductivity σ in the total structure has a highly nonlinear behavior due to local tunnel effect between adjacent clusters, and it can be varied at will by varying the voltage applied to the electrodes.

2. Nanostructure according to claim 1, wherein it consists of a metal film at percolation level.

3. Nanostructure according to claim 2, wherein the film is made of a metal chosen among Cu, Ag, Au, Al, Fe.

4. Nanostructure according to claim 1, wherein it consists of adjacent metal clusters, placed at a given distance one from the other so as to enable a high local electric field causing a tunnel effect.

5. Nanostructure according to claim 1, wherein it consists of clusters made of conductive polymer material.

6. Bidimensional or three-dimensional nanostructure according to claim 1, whose optical properties (in particular absorption, transmittance and reflectance, and therefore color) can be controlled at will by acting upon the voltage applied to the ends of said structure through lateral electrodes.

7. Bidimensional or three-dimensional nanostructure according to claim 6, in form of film characterized by a “flat” structure and comprising the following parts:
a transparent substrate made of glass or plastic material such as polycarbonate, methacrylate, CR39, etc.,
an active layer made of nanoporous material,
placed on the substrate,
two lateral electrodes connected to a supply, arranged on the substrate close to two opposite sides of the active layer, and
a transparent protective layer on the structure comprising the substrate, the active layer and the two lateral electrodes.

8. Bidimensional or three-dimensional nanostructure according to claim 6, used for varying the reflectance or transmittance of lenses for glasses, by supplying a solar cell (made of amorphous or polycrystalline silicon), which alone or coupled to a photodiode controls with feedback action the reflectance value.

9. Bidimensional or three-dimensional nanostructure according to claim 6, used for varying the reflectance and transmittance of a coating on a glass/plastic substrate of a building or car window and in particular of a rear-view mirror.

10. Bidimensional or three-dimensional percolated metal structure according to claim 1, having a shift in transmittance spectrum and thus in color.
